(19) United States
(12) Patent Application Publication
(10) Pub. No.: US 2017/0185286 A1
(43) Pub. Date: Jun. 29, 2017

(54) CONTINUOUS KEYBOARD RECOGNITION

(71) Applicant: Google Inc., Mountain View, CA (US)

(72) Inventors: Francoise Beaufays, Mountain View, CA (US); Yu Ouyang, San Jose, CA (US); David Rybach, Aachen (DE); Michael D. Riley, New York, NY (US); Lars Hellsten, Sunnyvale, CA (US)

(21) Appl. No.: 14/982,887

(22) Filed: Dec. 29, 2015

(51) Int. Cl. G06F 3/0488; G06F 3/01; G06F 3/041

(52) U.S. Cl. CPC G06F 3/04886; G06F 3/0416; G06F 3/017; G06F 2203/04106

(57) ABSTRACT

Methods, systems, and apparatus for receiving data indicating a location of a particular touchpoint representing a latest received touchpoint in a sequence of received touchpoints; identifying candidate characters associated with the particular touchpoint; generating, for each of the candidate characters, a confidence score; identifying different candidate sequences of characters each including for each received touchpoint, one candidate character associated with a location of the received touchpoint, and one of the candidate characters associated with the particular touchpoint; for each different candidate sequence of characters, determining a language model score and generating a transcription score based at least on the confidence score for one or more of the candidate characters in the candidate sequence of characters and the language model score for the candidate sequence of characters; selecting, and providing for output, a representative sequence of characters from among the candidate sequences of characters based at least on the transcription scores.

### FIELD

The present specification generally relates to keyboards.

### BACKGROUND

Many computing devices use a keyboard as one form of input device. For example, mobile computing devices, such as mobile telephones, smartphones, tablets, and wearable devices, have keyboard interfaces available to the user for making user inputs, but the keyboard interfaces may not be as easy to manipulate due to their smaller footprint, use of a touchscreen keyboard, or reduced number of keys. Accordingly, these keyboards pose difficulties to users and result in an increase in mistyped keys and a decrease in typing speed.

### SUMMARY

Implementations of the present disclosure relate to keyboard recognition, for example, of typed and/or gestured characters and words. In certain implementations, a finite state transducer (FST) decoder is used to perform keyboard recognition of typed and gestured words. In particular, a full decoding lattice may be implemented that allows for correction of previously typed words based on subsequently typed characters or words. Further, the full decoding lattice may allow for correct rendering of words inputted via a mixture of tap entry and gesture entry, as well as correct rendering of words when the “space” key is erroneously input or not input because the full decoding lattice treats a space as a character rather than treating a space as a word delimiter.

One innovative aspect of the subject matter described in this specification is embodied in methods that include the actions of receiving data indicating a location of a particular touchpoint on a touch display, the particular touchpoint representing a latest received touchpoint in a sequence of received touchpoints; identifying candidate characters associated with the location of the particular touchpoint; and generating, for each of the candidate characters associated with the particular touchpoint, a confidence score. The actions may further include identifying different candidate sequences of characters, each candidate sequence of characters comprising: (i) for each received touchpoint, one candidate character associated with a location of the received touchpoint, and (ii) one of the candidate characters associated with the location of the particular touchpoint; determining, for each different candidate sequence of characters, a language model score that indicates the likelihood of the occurrence of the candidate sequence of characters; and generating, for each different candidate sequence of characters, a transcription score based at least on: (i) the confidence score for one or more of the candidate characters in the candidate sequence of characters and (ii) the language model score for the candidate sequence of characters. In addition, the actions may include selecting a representative sequence of characters from among the candidate sequences of characters based at least on the transcription scores, and providing the representative sequence of characters for output.

These and other implementations may each optionally include one or more of the following features. For instance, the particular touchpoint may include one of a series of touchpoints in a swipe gesture. In addition, for instance, the candidate sequence of characters may include one or more words. In certain implementations, at least one of the candidate characters corresponds to a space character. In certain implementations, the sequence of received touchpoints comprises a series of touchpoints in a swipe gesture and the particular touchpoint comprises a touchpoint received via a tap input.

According to another aspect of the subject matter described in this specification, determining, for each different candidate sequence of characters, a language model score that indicates the likelihood of the occurrence of the candidate sequence of characters includes determining, for each different candidate sequence of characters, multiple language model scores associated with multiple respective language models

In certain implementations, identifying candidate characters associated with the location of the particular touchpoint includes identifying candidate characters associated with locations on the touch display within a predetermined distance from the location of the particular touchpoint on the touch display.

In certain implementations, determining, for each different candidate sequence of characters, a language model score that indicates the likelihood of the occurrence of the candidate sequence of characters includes determining, for each different candidate sequence of characters, multiple language model scores associated with multiple respective language models.

Other implementations of these aspects include corresponding systems, apparatus, and computer programs, configured to perform the actions of the methods, encoded on computer storage devices.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example diagram for operation of a continuous keyboard recognition system, according to certain implementations.

FIG. 2 depicts an example system for continuous keyboard recognition, according to certain implementations.

FIG. 3 depicts an example flowchart for a continuous keyboard recognition process, according to certain implementations.

FIG. 4 depicts an example of a computer device and a mobile computer device that may be used to implement the techniques described here.

Like reference numbers and designations in the various drawings indicate like elements.

### DETAILED DESCRIPTION

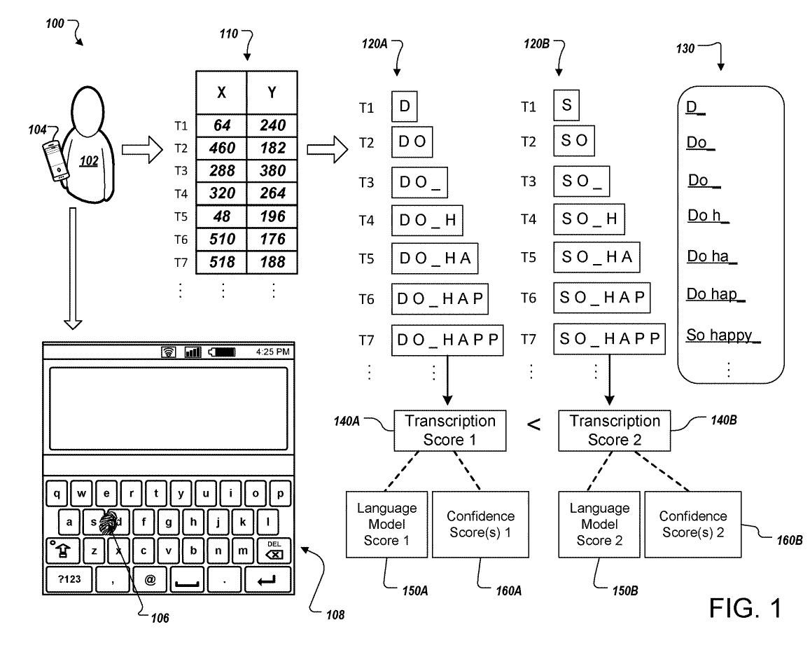

FIG. 1 depicts an example system 100 for continuous keyboard recognition, according to certain implementations. A user 102 may input characters using keys on a keyboard 108 of a mobile device 104. The keyboard 108 may be a virtual keyboard. The keyboard 108 may be a touch-sensitive keyboard displayed on a touchscreen. For example, the touch-sensitive keyboard may be part of a touch-sensitive surface coupled to or integrated with a display to form a touchscreen. Although examples may be described herein primarily in terms of a touch-sensitive keyboard displayed on a touchscreen, it should be understood that the disclosure is not so limited, but is additionally applicable to touch-sensitive keyboards in general, or any type of keyboard and display system.

In general, according to certain implementations, a full decoding lattice may be implemented that allows for correction of previously typed words based on subsequently typed characters or words. Further, the full decoding lattice may allow for correct rendering of words inputted via a mixture of tap entry and gesture entry, as well as correct rendering of words when the “space” key is erroneously input or not input because the full decoding lattice treats a space as a character rather than treating a space as a word delimiter. For example, if the characters “d”, “o”, “space”, “h”, “a”, “p”, “p” are input, the system may determine the second word is “happy” and correct the first word from “do” to “so” based on the subsequently input characters corresponding to the word “happy”. Further, for example, if a user gestures “accomplish”, pauses or stops contact with the input surface, then gestures “ment,” and then taps “s”, the system may determine that the input corresponds to the word “accomplishments” rather than separate words indicated by an auto-space inserted between “accomplish” and “ment” and between “ment” and “s”. Additionally, if the “space” key is erroneously input in typing, for example, “weeke d”, i.e., the “space” key is input instead of the “n” key, the system may correctly render the word “weekend” rather than, for example, “weeks d” when the space indicates a word delimiter. Similarly, if the “space” key is erroneously not inputted in typing, the system may correctly render the words or phrase with a space inserted. For example, “thebest” may be correctly rendered as “the best” by the FST decoder.

Referring to FIG. 1, one or more touchpoints may be received on the touch-sensitive keyboard, as inputted by the user 102. The one or more touchpoints may be in the form of a tap on the touch-sensitive keyboard or a swipe gesture on the touch-sensitive keyboard. A gesture may correspond to stationary or non-stationary, single or multiple, touches or near touches on the touch-sensitive keyboard. A gesture may be performed by moving one or more fingers or other objects in a particular manner on the touch-sensitive keyboard such as pinching, sliding, swiping, rotating, flexing, dragging, tapping, pressing, rocking, scrubbing, twisting, changing orientation, pressing with varying pressure and the like at essentially the same time, contiguously, or consecutively. For example, a swipe gesture may include a touchdown of a touch object followed by a sliding motion of the touch object across the virtual keyboard. Thus, directional swipes or swipe gestures over the touch-sensitive keyboard may be used as an alternative to striking certain keys via a tap.

Data 110 corresponding to locations of the one or more touchpoints may be received based on the input. For example, the data may include an x-y coordinate 110 of each touchpoint received at different timings. As depicted in FIG. 1, at T1, a touchpoint 106 corresponding to x-y coordinates of (64, 240) may be received, while at T2, a touchpoint corresponding to x-y coordinates of (460, 182) may be received. Based on the location of the touchpoint, one or more candidate characters may be identified. The candidate characters may be identified as characters represented on the keyboard at or near the location of the touchpoint. The candidate characters may represent probable characters inputted via the keyboard based on the location of the touchpoint. For example, the candidate characters may be identified based on a probability distribution over keys of the touch-sensitive keyboard proximate to a location of the touchpoint.

If location data of a touchpoint indicates that the touch point is proximate to the “J”, “K”, and “M” keys on the touch-sensitive keyboard, for example, then the determination of the corresponding key and character may be based on a probability distribution over the “J”, “K”, and “M” keys. The probabilities may be based on, for example, a distance to each key, usage frequency of each key, a previously-typed letter, and/or other factors. For a given touchpoint, for example, the probability for “M” may be relatively high because the touchpoint is very close to the center of the “M” key, whereas the probability for “J” may be relatively low because the “J” key might be rarely typed.

A confidence score may be generated for each of the candidate characters associated with a particular touchpoint. The confidence score may be generated based on the probability distribution itself or may be generated based on other factors in addition to, or instead of, the probability distribution. As depicted in FIG. 1, inputted characters may be determined based on the location data 110. For example, given the location data of x-y coordinates (64, 240) at T1 for touchpoint 106, the corresponding candidate characters may be identified as “D” and “S”. Based on, for example, the confidence scores generated for each of candidate characters “D” and “S”, the key inputted on the keyboard may be determined to be the character “D”. The output 130 may include “D” corresponding to the data at T1.

A lattice structure may be generated for the data associated with the candidate characters that are identified based on the touchpoints. Each path through the lattice may correspond to a different sequence of the identified candidate characters for each touchpoint. Thus, different candidate sequences of characters may be identified for the inputted touchpoints. Each candidate sequence of characters may include, for each received touchpoint, one candidate character associated with the location of the received touchpoint. For example, for a particular touchpoint received, e.g., a most recently received touchpoint, a candidate sequence of characters may include one candidate character associated with the location of each touchpoint received prior to the particular touchpoint, and one of the candidate characters associated with the location of the particular touchpoint.

The lattice may allow for an output ranking the candidate sequences of characters based on a score. The score may be based on the confidence scores generated for each of the candidate characters associated with respective touchpoints in each candidate sequence of characters. For example, a probability for each of the candidate sequences of characters may be determined based on probabilities for each of the candidate characters in the respective candidate sequence of characters.

In certain implementations, using transliterated languages, e.g., with a transliteration keyboard, transliteration and conversion models may be represented as FSTs that are included with or added in the lattice. Thus, for example, the full decoding lattice may include the transliteration and conversion models as well as the language model, which may provide global optimal decoding over all the models for inputted text via candidate sequences of characters. Further, in certain implementations, when the inputted language is an unsegmented language, e.g., Thai, Khmer, or the like, because the full decoding lattice treats a space as a character rather than treating a space as a word delimiter, for example, the inputted text may be rendered regardless of the segmentation of the inputted text. For example, if a first word is inputted via a first gesture, and then a second word is inputted via a second gesture, where contact with the input surface is not continuous or contact is stopped between words, the system may render the inputted text for an unsegmented language without a space between the words.

Referring to T2 of FIG. 1, given the location data of x-y coordinates (460, 182), the corresponding candidate character may be “O”. A first candidate sequence of characters 120A as “DO” and a second candidate sequence of characters 120B as “SO” may be determined from the candidate characters. Based on, for example, a respective transcription score 140A and 1406 generated for each of the candidate sequence of characters 120A and 120B, the corresponding key inputted on the keyboard may be determined to be the character “O” as part of the candidate sequence of characters “DO”. The output 130 may include “Do” corresponding to the data at T2.

For each different candidate sequence of characters, a language model score may be determined that indicates the likelihood of the occurrence of the candidate sequence of characters. The language model score may be based on one or more language model scores generated via one or more respective language models. For example, the language model score for a particular candidate sequence of characters may indicate a probability that the particular candidate sequence of characters occurs in the inputted language.

With reference to FIG. 1, at T1, which corresponds to a first touchpoint having x-y coordinates (64, 240), the character “D” may be identified as the one of the candidate characters for that touchpoint location that is most probable to have been inputted via the keyboard. At T2, which corresponds to a second touchpoint having x-y coordinates (460, 182), the character “0” may be identified as the one of the candidate characters for that touchpoint location and the sequence of characters “D-O” may be identified as one of the candidate sequences of characters.

The output 130 may be provided as “Do” based on the confidence scores associated with the candidate characters “D” and “O,” and based on the language model score for the candidate sequence of characters “D-O”. For example, the aggregated confidence scores for candidate characters “D” and “0” and the language model score for the candidate sequence of characters “D-O” may indicate that “Do” is the most probable sequence of characters for the locations of the touchpoints inputted for T1 and T2. Thus, for example, the system may provide text for output 130 corresponding to “Do” in response to receiving the touchpoint having x-y coordinates (460, 182) after receiving the touchpoint having x-y coordinates (64, 240).

In certain implementations, the character output may not be the one of the candidate characters for a touchpoint location that is most probable to have been inputted via the keyboard, but rather the candidate sequence of characters including that candidate character may indicate the sequence of characters to be the most probable sequence of characters. For example, the character “O” may not be identified as the one of the candidate characters that is most probable for that touchpoint location, but the sequence of characters “D-O” may be identified as the most probable sequence of characters. Thus, for example, even when the character “O” may be the second-most probable of the candidate characters for a particular touchpoint location, the output 130 may be “Do” based on the sequence of characters “D-O” being identified as the most probable sequence of characters of the candidate sequences of characters using the respective language model scores.

Further referring to FIG. 1, at T3, which corresponds to a third touchpoint having x-y coordinates (288, 380), the “space” character may be identified as the one of the candidate characters for that touchpoint location. The “space” character may be identified, for example, as the candidate character that is most probable to have been inputted via the keyboard. The system may treat the “space” character similar to any other character, rather than as a delimiter between words or phrases. The output 130 may be provided as “Do_”, where “_” is being used to indicate a “space”, based on the confidence scores associated with the candidate characters “D”, “O,” and “space”, and based on the language model score for the candidate sequence of characters “D-O-_”.

At T4, which corresponds to a fourth touchpoint having x-y coordinates (320, 264), the “H” character may be identified as one of the candidate characters for that touchpoint location. The output 130 may be provided as “Do_h”, where “_” is being used to indicate a “space”, based on the confidence scores associated with the candidate characters “D”, “O,” “space”, and “H”, and based on the language model score for the candidate sequence of characters “D-O-_-H”.

At T5, which corresponds to a fifth touchpoint having x-y coordinates (48, 196), the “A” character may be identified as one of the candidate characters for that touchpoint location. The output 130 may be provided as “Do_ha”, where “_” is being used to indicate a “space”, based on the confidence scores associated with the candidate characters “D”, “O,” “space”, “H”, and “A”, and based on the language model score for the candidate sequence of characters “D-O-_-H-A”.

At T6, which corresponds to a sixth touchpoint having x-y coordinates (510, 176), the “P” character may be identified as one of the candidate characters for that touchpoint location. The output 130 may be provided as “Do_hap”, where “_” is being used to indicate a “space”, based on the confidence scores associated with the candidate characters “D”, “O,” “space”, “H”, “A”, and “P”, and based on the language model score for the candidate sequence of characters “D-O-_-H-A-P”.

At T7, which corresponds to a seventh touchpoint having x-y coordinates (518, 188), the “P” character may be identified as one of the candidate characters for that touchpoint location. The output 130 may be provided as “So_happ”, where “_” is being used to indicate a “space”, based on the confidence scores associated with the candidate characters “S”, “O,” “space”, “H”, “A”, “P”, and “P”, and based on the language model score for the candidate sequence of characters “S-O-_-H-A-P-P”. Thus, for example, the output 130 may change the initial word from “Do” to “So” due to the candidate sequence of characters “S-O-_-H-A-P-P” being selected, rather than the candidate sequence of characters “D-O-_-H-A-P-P”, based on respective transcription scores 140A and 140B. The transcription score may be generated for each candidate sequence of characters based at least on the confidence score 160A and 160B for one or more of the candidate characters in the candidate sequence of characters and the language model score 150A and 1506 for the candidate sequence of characters. Similarly, as described above with respect to each of T1-T6, the output 130 may be based on the transcription score associated with respective candidate sequences of characters. Thus, for example, a transcription score 140A associated with the candidate sequence of characters “D-O-_-H-A-P-P” may be generated based on a language model score 150A and one or more confidence scores 160A for respective candidate characters. Similarly, for example, a transcription score 140B associated with the candidate sequence of characters “S-O-_-H-A-P-P” may be generated based on a language model score 150B and one or more confidence scores 160B for respective candidate characters.

In certain implementations, the candidate sequence of characters may include candidate characters that may be identified as characters in a word or phrase that occur after the candidate characters associated with the location of the particular touchpoint most recently received. For example, based on the candidate characters associated with respective locations of touchpoints, word recommendations may be provided that include additional characters. Thus, as text is entered by a user, one or more candidate sequences of characters, e.g., suggested replacements, may be provided and a candidate sequence of characters may be selected to further extend or to complete the entered text. Accordingly, if candidate characters associated with respective locations of touchpoints are identified as “H-A-P-P”, a candidate sequence of characters may be provided to complete the word to be “H-A-P-P-Y”. The word completion or replacement recommendations may be drawn from a dictionary, language model, or the like, and the dictionary may include usage frequency rankings associated with the words in the dictionary.

Referring to FIG. 1, at T7 corresponding to the seventh touchpoint, the “P” character may be identified as one of the candidate characters, and the output 130 may be provided as “So happy” based on the confidence scores associated with the candidate characters “S”, “O,” “space”, “H”, “A”, “P”, and “P”, and based on the language model score for the candidate sequence of characters “S-O-_-H-A-P-P-Y”. In this example, the candidate sequence of characters may include candidate characters, one of which is the character “Y”, identified as characters in a word or phrase that occur after the candidate characters associated with the location of the seventh touchpoint. Thus, for example, a word recommendation of “happy” may be provided for the output 130 to be “So happy”. The word recommendation of “happy” may be output based on: a word recognition engine using a dictionary, language model, or the like, or any combination thereof; the language model score associate with the candidate sequence of characters; the confidence scores associated with the candidate characters; or any combination thereof. Accordingly, at T7, a transcription score 140B may be generated for the candidate sequence of characters “S-O-_-H-A-P-P-Y” based on a language model score 150B for that candidate sequence of characters and one or more confidence scores 160B of respective candidate characters in that candidate sequence of characters. In addition, a transcription score 140A may be generated for the candidate sequence of characters “D-O-_-H-A-P-P-Y” based on a language model score 150A for that candidate sequence of characters and one or more confidence scores 160A of respective candidate characters in that candidate sequence of characters. In the illustrated example, the transcription score 140B associated with the candidate sequence of characters “S-O-_-H-A-P-P-Y” may be greater than the transcription score 140A associated with the candidate sequence of characters “D-O-_-H-A-P-P-Y”. Thus, the system may select the candidate sequence of characters “S-O-_-H-A-P-P-Y” and provide for output 130 the phrase “So happy”. Hence, from a user's perspective, typing the second “P” character at T7 may result in the output 130 changing from “Do hap” to “So happy”.

Because the system may treat the “space” character similar to any other character, rather than as a delimiter between words or phrases, the output of text is based on the selected representative sequence of characters from among the candidate sequences of characters based at least on the transcription scores. In other words, the “space” character may be treated as one of the candidate characters associated with a touchpoint. Thus, an accidental input of the “space” character, e.g., in which the touchpoint location corresponds to the spacebar, may be corrected in the output of text. Similarly, an accidental omission of the “space” character may be corrected in the output of text. For example, the transcription score corresponding to a candidate sequence of characters that includes a character other than “space” may result in an output in which another of the candidate characters corresponding to the touchpoint for which the “space” is a candidate character is selected. Accordingly, if the typed input corresponds to “W-E-E-K-E-_-D”, e.g., the user accidentally inputted “space” instead of “N”, the system may correct the outputted text to be “weekend” based on selecting the candidate sequence of characters “W-E-E-K-E-N-D” over the candidate sequence of characters “W-E-E-K-E-_-D” or another alternative candidate sequence of characters, in accordance with their respective transcription scores. In other words, the transcription scores indicate that the sequence of characters selected should cause the outputted text to be “weekend” rather than “weeke d”, or “weke d”, or “week d”, or some other alternative.

In certain implementations, the lattice structure may be generated for the full string of touchpoints that are inputted in a given input session. Alternatively, the lattice structure may be generated for a predetermined portion of touchpoints inputted or for a predetermined number of touchpoints inputted. However, because the lattice structure is generated for multiple touchpoints, and candidate sequences of characters are analyzed that include respective candidate characters for the multiple touchpoints, the system does not solely rely on the concept of individual words delimited by a space or other character. Thus, the full decoding lattice described herein allows for the outputted text to correct a word that was previously typed incorrectly based on a newly typed word and allows for correct rendering of words when the “space” key is accidentally input, e.g., instead of nearby keys “V”, “B”, or “N”, or accidentally omitted. For example, if the input typed by a user corresponds to “do happy to se rou lst weke d,” the continuous keyboard recognition engine of the present disclosure may output for display “so happy to see you last weekend”.

In addition, the full decoding lattice described herein allows for correct rendering of words entered with a mix of tap input and gesture input or with a pause between gesture swipes or a lifting of the input object from the touchscreen between gesture swipes. For example, if the input typed by a user via a swipe gesture corresponds to “accomplish,” and then the next swipe gesture corresponds to “ment,” and then an input, typed via a tap, corresponds to “s,” the continuous keyboard recognition engine of the present disclosure may output for display “accomplishments,” rather than “accomplish needn't s”. However, if the user continues to type via tap input the characters “H”, “O”, “U”, “L”, and “D”, the continuous keyboard recognition engine of the present disclosure may determine that the previously input “S” corresponds to the start of a new word, “should”, and may output “accomplishment should”.

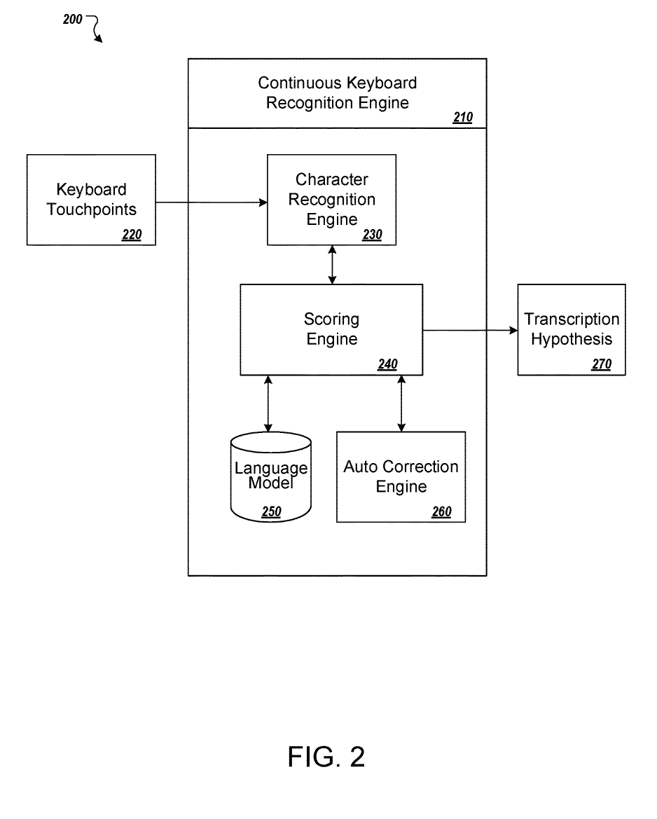

FIG. 2 depicts an example system 200 for continuous keyboard recognition, according to certain implementations. The system 200 may include a continuous keyboard recognition engine 210. Keyboard touchpoints 220 may be received that may be input via a touchscreen. For example, a touch-sensitive keyboard may be part of a touch-sensitive surface such as a touchpad. The touch-sensitive keyboard may be part of a touch-sensitive surface coupled to or integrated with a display to form a touchscreen. The touch-sensitive keyboard itself may be displayed on the touchscreen.

The continuous keyboard recognition engine 210 may include a character recognition engine 230, a scoring engine 240, a language model 250, and an auto correction engine 260. The character recognition engine 230 may identify one or more candidate characters based on data indicating the location of the touchpoint received. The candidate characters may be identified as characters represented on the keyboard at or near the location of the touchpoint. For example, the candidate characters may be identified based on a probability distribution over keys of the touch-sensitive keyboard proximate to a location of the touchpoint. The character recognition engine 230, either alone or in conjunction with the scoring engine 240, may generate a confidence score for each of the candidate characters associated with a particular touchpoint. The confidence score may be generated based on the probability distribution itself or may be generated based on other factors in addition to, or instead of, the probability distribution.

The character recognition engine 230 may generate the lattice structure for the data associated with the candidate characters that are identified based on the touchpoints. Each path through the lattice may correspond to a different sequence of the identified candidate characters for each touchpoint. Thus, different candidate sequences of characters may be identified for the inputted touchpoints. The lattice generated by the character recognition engine 230 may allow for an output ranking the candidate sequences of characters based on a score, for example in conjunction with the scoring engine 240. The score may be based on the confidence scores generated for each of the candidate characters associated with respective touchpoints in each candidate sequence of characters.

The language model 250 may include one or more language models that indicate the likelihood of the occurrence of particular words and/or sequences of characters. The language model 250, either alone or in conjunction with the scoring engine 240, may generate a language model score for each different candidate sequence of characters. The generated language model score may indicate the likelihood of the occurrence of the candidate sequence of characters. The language model score may be based on one or more language model scores generated via one or more respective language models 250. For example, the language model score for a particular candidate sequence of characters may indicate a probability that the particular candidate sequence of characters occurs in the inputted language. A language model 250 may be selected from multiple language models available to the continuous keyboard recognition engine 210 based on predetermined settings, user preferences, text that is input, usage history, the application associated with the text input, context information, or the like, or any combination thereof.

The auto correction engine 260 may include a word recognition module and may be used to identify common misspellings of words, common grammatical errors, common typographical errors, or the like, or any combination thereof. The auto correction engine 260 may be customized to a particular user based on learning common misspellings of words, common grammatical errors, common typographical errors, or the like, or any combination thereof, made by the particular user.

The scoring engine 240 may generate a transcription score for each candidate sequence of characters based at least on the confidence score for one or more of the candidate characters in the candidate sequence of characters, which may be generated with the character recognition engine 230, and the language model score for the candidate sequence of characters, which may be generated with the language model 250. The scoring engine 240 may rank candidate sequences of characters based on the transcription score. One of the candidate sequences of characters may be selected as a representative sequence of characters or transcription hypothesis 270. The representative sequence of characters may be provided for output as a transcription hypothesis 270 for the inputted text.

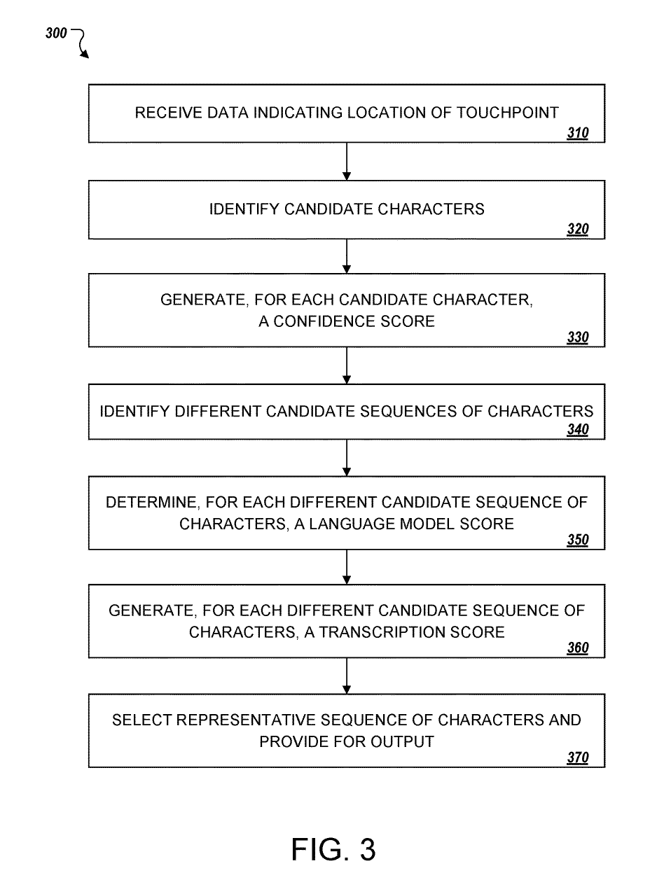

FIG. 3 depicts an example flowchart for a continuous keyboard recognition process 300, according to certain implementations. The continuous keyboard recognition process 300 may include receiving data indicating a location of a particular touchpoint on a touch display at 310. The particular touchpoint may represent a latest received touchpoint in a sequence of received touchpoints on the touch display. In certain implementations, the sequence of received touchpoints may include a series of touchpoints in a swipe gesture and the particular touchpoint may correspond to a touchpoint received via a tap input. In certain implementations, the particular touchpoint may correspond to one of a series of touchpoints in a swipe gesture.

At 320, candidate characters associated with the location of the particular touchpoint may be identified. In certain implementations, identifying candidate characters associated with the location of the particular touchpoint may include identifying candidate characters associated with locations on the touch display within a predetermined distance from the location of the particular touchpoint on the touch display. For example, if the location of the particular touchpoint is at a location between the display of the “N”, “B”, and “H” characters, and each of the “N”, “B”, and “H” characters are displayed at locations within a predetermined distance from the location of the particular touchpoint, the “N”, “B”, and “H” characters may be identified as candidate characters for the particular touchpoint. As another example, if the location of the particular touchpoint is at a location between the display of the “N” and “B” characters, and in addition to each of the “N” and “B” being displayed at locations within a predetermined distance from the location of the particular touchpoint, the spacebar is also displayed at a location within a predetermined distance from the location of the particular touchpoint, then the “N”, “B”, and “space” characters may be identified as candidate characters for the particular touchpoint.

In certain implementations, the candidate characters may be identified based on a probability distribution over keys of the touch-sensitive keyboard proximate to a location of the touchpoint. The continuous keyboard recognition process 300 may include generating a confidence score for each of the candidate characters associated with the particular touchpoint at 330. The confidence score may be generated based on the probability distribution itself or may be generated based on other factors in addition to, or instead of, the probability distribution.

At 340, different candidate sequences of characters may be identified. Each candidate sequence of characters may include, for each received touchpoint, one candidate character associated with a location of the received touchpoint. Each candidate sequence of characters may also include one of the candidate characters associated with the location of the particular touchpoint. In certain implementations, the candidate sequence of characters may include one or more words.

The continuous keyboard recognition process 300 may include determining, for each different candidate sequence of characters, a language model score that indicates the likelihood of the occurrence of the candidate sequence of characters at 350. In certain implementations, determining the language model score may include determining, for each different candidate sequence of characters, multiple language model scores associated with multiple respective language models.

At 360, for each different candidate sequence of characters, a transcription score may be generated. The transcription score may be based on the confidence score for one or more of the candidate characters in the candidate sequence of characters. The transcription score may also be based on the language model score for the candidate sequence of characters. Other factors may also impact the generated language model score.

The continuous keyboard recognition process 300 may include selecting a representative sequence of characters from among the candidate sequences of characters based at least on the transcription scores at 370. Further, the representative sequence of characters may be provided for output at 370.

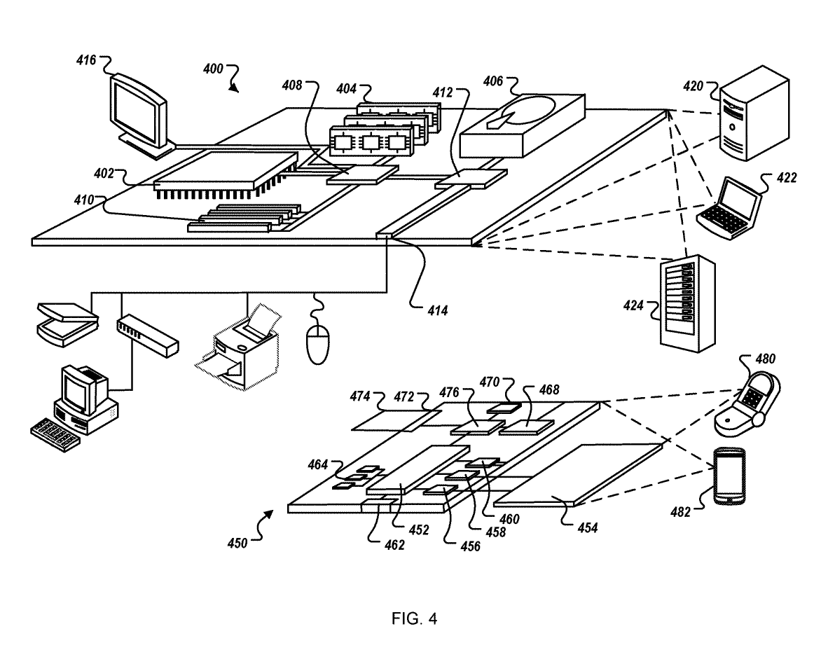

FIG. 4 depicts an example of a generic computer device 400 and a generic mobile computer device 450, which may be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 may process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier is a computer- or machine-readable medium, such as the memory 404, the storage device 406, or a memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 may execute instructions within the computing device 640, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 648 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 may be implemented as one or more of a computer-readable medium or media, a volatile memory unit or units, or a non-volatile memory unit or units. Expansion memory 454 may also be provided and connected to device 450 through expansion interface 452, which may include, for example, a SIMM (Single In Line Memory Module) card interface. Such expansion memory 454 may provide extra storage space for device 450, or may also store applications or other information for device 450. Specifically, expansion memory 454 may include instructions to carry out or supplement the processes described above, and may include secure information also. Thus, for example, expansion memory 454 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 454, memory on processor 452, or a propagated signal that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 450 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Implementations of the invention and all of the functional operations described in this specification can be implemented in digital electronic circuitry, or in computer software, firmware, or hardware, including the structures disclosed in this specification and their structural equivalents, or in combinations of one or more of them. Implementations of the invention can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving data indicating a location of a particular touchpoint on a touch display, wherein the particular touchpoint represents a latest received touchpoint in a sequence of received touchpoints;
identifying candidate characters associated with the location of the particular touchpoint;
generating, for each of the candidate characters associated with the location of the particular touchpoint, a confidence score;
identifying different candidate sequences of characters, each candidate sequence of characters comprising: (i) for each received touchpoint, one candidate character associated with a location of the received touchpoint, and (ii) one of the candidate characters associated with the location of the particular touchpoint;
determining, for each different candidate sequence of characters, a language model score that indicates the likelihood of the occurrence of the candidate sequence of characters;
generating, for each different candidate sequence of characters, a transcription score based at least on: (i) the confidence score for one or more of the candidate characters in the candidate sequence of characters and (ii) the language model score for the candidate sequence of characters;
selecting a representative sequence of characters from among the candidate sequences of characters based at least on the transcription scores;
providing the representative sequence of characters for output.

2. The computer-implemented method of claim 1, wherein the particular touchpoint comprises one of a series of touchpoints in a swipe gesture.

3. The computer-implemented method of claim 1, wherein the candidate sequence of characters comprises one or more words.

4. The computer-implemented method of claim 1, wherein identifying candidate characters associated with the location of the particular touchpoint comprises identifying candidate characters associated with locations on the touch display within a predetermined distance from the location of the particular touchpoint on the touch display.

5. The computer-implemented method of claim 1, wherein at least one of the candidate characters corresponds to a space character.

6. The computer-implemented method of claim 1, wherein determining, for each different candidate sequence of characters, a language model score that indicates the likelihood of the occurrence of the candidate sequence of characters comprises determining, for each different candidate sequence of characters, multiple language model scores associated with multiple respective language models.

7. The computer-implemented method of claim 1, wherein the sequence of received touchpoints comprises a series of touchpoints in a swipe gesture and the particular touchpoint comprises a touchpoint received via a tap input.

8. A system comprising one or more computers and one or more storage devices storing instructions that are operable, when executed by the one or more computers, to cause the one or more computers to perform operations comprising:
receiving data indicating a location of a particular touchpoint on a touch display, wherein the particular touchpoint represents a latest received touchpoint in a sequence of received touchpoints;
identifying candidate characters associated with the location of the particular touchpoint;
generating, for each of the candidate characters associated with the location of the particular touchpoint, a confidence score;
identifying different candidate sequences of characters, each candidate sequence of characters comprising: (i) for each received touchpoint, one candidate character associated with a location of the received touchpoint, and (ii) one of the candidate characters associated with the location of the particular touchpoint;
determining, for each different candidate sequence of characters, a language model score that indicates the likelihood of the occurrence of the candidate sequence of characters;
generating, for each different candidate sequence of characters, a transcription score based at least on: (i) the confidence score for one or more of the candidate characters in the candidate sequence of characters and (ii) the language model score for the candidate sequence of characters;
selecting a representative sequence of characters from among the candidate sequences of characters based at least on the transcription scores;
providing the representative sequence of characters for output.

9. The system of claim 8, wherein the particular touchpoint comprises one of a series of touchpoints in a swipe gesture.

10. The system of claim 8, wherein the candidate sequence of characters comprises one or more words.

11. The system of claim 8, wherein identifying candidate characters associated with the location of the particular touchpoint comprises identifying candidate characters associated with locations on the touch display within a predetermined distance from the location of the particular touchpoint on the touch display.

12. The system of claim 8, wherein at least one of the candidate characters corresponds to a space character.

13. The system of claim 8, wherein determining, for each different candidate sequence of characters, a language model score that indicates the likelihood of the occurrence of the candidate sequence of characters comprises determining, for each different candidate sequence of characters, multiple language model scores associated with multiple respective language models.

14. The system of claim 8, wherein the sequence of received touchpoints comprises a series of touchpoints in a swipe gesture and the particular touchpoint comprises a touchpoint received via a tap input.

15. A computer-readable storage device storing software comprising instructions executable by one or more computers which, upon such execution, cause the one or more computers to perform operations comprising:
receiving data indicating a location of a particular touchpoint on a touch display, wherein the particular touchpoint represents a latest received touchpoint in a sequence of received touchpoints;
identifying candidate characters associated with the location of the particular touchpoint;
generating, for each of the candidate characters associated with the location of the particular touchpoint, a confidence score;
identifying different candidate sequences of characters, each candidate sequence of characters comprising: (i) for each received touchpoint, one candidate character associated with a location of the received touchpoint, and (ii) one of the candidate characters associated with the location of the particular touchpoint;
determining, for each different candidate sequence of characters, a language model score that indicates the likelihood of the occurrence of the candidate sequence of characters;
generating, for each different candidate sequence of characters, a transcription score based at least on: (i) the confidence score for one or more of the candidate characters in the candidate sequence of characters and (ii) the language model score for the candidate sequence of characters;
selecting a representative sequence of characters from among the candidate sequences of characters based at least on the transcription scores;
providing the representative sequence of characters for output.

16. The computer-readable storage device of claim 15, wherein the particular touchpoint comprises one of a series of touchpoints in a swipe gesture.

17. The computer-readable storage device of claim 15, wherein the candidate sequence of characters comprises one or more words.

18. The computer-readable storage device of claim 15, wherein identifying candidate characters associated with the location of the particular touchpoint comprises identifying candidate characters associated with locations on the touch display within a predetermined distance from the location of the particular touchpoint on the touch display.

19. The computer-readable storage device of claim 15, wherein determining, for each different candidate sequence of characters, a language model score that indicates the likelihood of the occurrence of the candidate sequence of characters comprises determining, for each different candidate sequence of characters, multiple language model scores associated with multiple respective language models.

20. The computer-readable storage device of claim 15, wherein the sequence of received touchpoints comprises a series of touchpoints in a swipe gesture and the particular touchpoint comprises a touchpoint received via a tap input.
